(19) United States
(12) Patent Application Publication
(10) Pub. No.: US 2017/0353018 A1
(43) Pub. Date: Dec. 7, 2017

(54) SPECIAL END PIECE FOR A NEEDLE INTENDED TO BE PUSHED INTO A SHEATH OCCUPIED BY CABLES

(71) Applicant: Orange, Paris (FR)

(72) Inventors: Daniel Lecoq, Berhet (FR); Jean-Luc Campion, Saint Quay Perros (FR); Francoise Lissillour, Tregastel (FR)

(73) Assignee: ORANGE, Paris (FR)

(21) Appl. No.: 15/536,327

(22) PCT Filed: Dec. 10, 2015
(86) PCT No.: PCT/FR2015/053422

§ 371 Date: Jun. 15, 2017

(30) Foreign Application Priority Data
Dec. 18, 2014 (FR) 1462812

(51) Int. Cl. H02G 1/08; G02B 6/44

(52) U.S. Cl. CPC H02G 1/083; G02B 6/4463

(57) ABSTRACT

An end piece is provided for guiding a needle intended to be inserted in a sheath occupied by at least one installed cable. The end piece includes: a free first end referred to as a head of a shape suited to slipping in between an internal wall of the sheath and the at least one installed cable; a second end fixed to the needle; and a part connecting the two ends and referred to as a shank. The shank has a flexibility that increases toward the head.

### 1. FIELD OF THE INVENTION

The invention application falls in the field of electrical or optical wiring and more particularly in the field of the insertion of a cable into a sheath already occupied by one or more cables.

### 2. PRIOR ART

In domestic or company premises, the cables for connecting the electricity, the television, the telephone or the Internet, whether these be electrical or optical connections, are generally hidden away in sheaths, also called conduits, inside the walls.

Before it is installed inside a wall a sheath is generally preequipped either with a cable or with a cable-threading needle intended to be pulled out from one end of the sheath, a cable being attached to the other end and being inserted into the sheath by pulling.

When the sheath does not have a needle, one conventional technique for inserting a cable into it is to introduce a needle therein beforehand.

Commercially available needles intended to be pushed into a sheath are usually equipped at their end with a part that is flexible over a few centimeters in order to start the passage around the bends encountered en route, and with an end piece with an olive-shaped head so as not to butt against the internal ringing of the sheath, when the sheath is corrugated.

Certain cables are rigid enough to be “pushable” into a sheath and can be inserted therein in the manner of a needle, and then left in place, avoiding the need to resort to a needle in an intermediate pushing step. In that case, the cable acts like the needle during this pushing step. This is why in this document, a “needle” is to be understood both to mean a rod intended to be inserted by pushing into a sheath and then removed from the sheath by pulling, and a cable intended to be inserted by pushing into a sheath in order to install it definitively therein.

In order for the pushed cable not to butt against the rings on the internal wall of the sheath, the end of the cable is bent over.

These solutions are ineffective at inserting a cable into a sheath that is already occupied, for example an optical cable measuring 3.8 mm in cross-sectional diameter, when the sheath is of small diameter, as in the case of a sheath with an inside diameter of 11 mm, when this is already occupied by a cable, for example a coaxial cable 7 mm in diameter.

These solutions are ineffective for inserting a cable, for example an optical cable measuring 3.8 mm in diameter, into a small-diameter sheath, for example a sheath with an inside diameter of 11 mm, when it is already occupied by a cable, for example a coaxial cable 7 mm in diameter.

It is one of the objects of the invention to overcome these drawbacks of the prior art.

### 3. SUMMARY OF THE INVENTION

The invention seeks to improve the situation using an end piece for guiding a needle intended to be inserted in a sheath occupied by at least one installed cable, the end piece comprising:
a free first end referred to as the head, of a shape suited to slipping in between the internal wall of the sheath and the at least one installed cable,
a second end fixed to the needle,
a part connecting the two ends and referred to as the shank, of flexibility that increases toward the head.

The head of the end piece, because of its carefully chosen shape, guides the shank and the needle fixed to the end thereof, in the space left free in the sheath by the cable or cables already installed therein. Thus, when the needle is inserted into the sheath, the head opens a tunnel for the needle. When one of the installed cables is not in perfect alignment and encroaches on the alignment of the free space, it is pushed out of the way by the head of the end piece. The word “alignment” should be understood as meaning a path substantially following the axis of the sheath, namely a path in a straight line in a straight segment of the sheath, or a path in a curve in a curved segment of the sheath.

This suitable shape, combined with the progressive flexibility of the shank both in bending and in torsion, allows the head and the rod to enter a direction change of the sheath in a curve, even abrupt, and even when one of the cables installed has deviated from its alignment in the curve.

It is particularly in the sheath segments that involve a direction change, and therefore in curves, that the cable or cables installed are actually going to take up the space left free and need to be pushed to one side in order to allow the needle to pass.

In addition, by making it easier to enter bends in the sheath, the progressive flexibility of the rod eliminates the buckling of the needle, namely the corrugating of the needle in the sheath under a pushing force that has become excessive if the needle is inserted by pushing. Buckling increases the risk of the needle becoming jammed or even broken.

Thanks to the end piece according to the invention it will be appreciated that the needle is able without difficulty to negotiate the curves taken by the sheath, even if the sheath is already occupied by one or more already-installed cables.

It should be noted that the advantages of the end piece are also obtained when the needle is inserted by pulling, namely by the removal from the sheath either of another needle already inserted or of a cable already inserted, the other needle or the cable already installed being attached to the end piece by any arbitrary means.

According to one aspect of the invention, the head comprises a partially cylindrical convex upper face and a partially cylindrical concave lower face.

The space left free in the sheath by the cable or cables already installed therein, when viewed in cross section at right angles to the sheath, has a particular shape. Specifically, the cable or cables already installed, when they touch one another, together form a cable bundle the cross section of which is generally circular, and which has a diameter less than the inside diameter of the sheath. The weight and rigidity of the cables in curves have the effect that this bundle of cables touches the interior wall of the sheath, giving the cross section of the space left free a shape that can be approximated to that of a lunar crescent.

Because of its convex shape on the top and concave shape on the bottom, the head also has a shape approximating to that of a lunar crescent, when viewed in its cross section perpendicular to the sheath.

As the end piece advances in the sheath, the upper face of the head slides against the internal wall of the sheath and the lower face slides against the installed cable or cables. Thus, the head pushes back the cable or cables encroaching into the free space so that they remain in bundles, thereby freeing up and maximizing the empty space.

In the common instances in which there is just one cable already installed in the sheath, and the cable is circular in shape, such as, for example, a coaxial cable measuring 7 mm in a sheath of 11 mm inside diameter, a head with a cross section in the shape of a lunar crescent is particularly well suited.

According to one aspect of the invention, the radius of curvature of the convex upper face is less than the interior radius of the sheath.

By virtue of this aspect, the head of the end piece slides more easily against the internal wall of the sheath, and more readily guides the needle in the space left empty in the sheath by the installed cable or cables. One of the smallest sheaths intended for electrical or optical cables measures 10 mm inside diameter. For such a sheath, the radius of curvature of the convex cylindrical surface of the head needs to be less than 5 mm.

According to one aspect of the invention, the radius of curvature of the concave lower face is greater than the radius of the cross section of a bundle formed by the at least one installed cable.

By virtue of this aspect, the head of the end piece slides more readily against the surface of the cable or cables already installed in the sheath, and more readily guides the needle in the space left empty in the sheath by the installed cable or cables. One of the fattest cables suited to interior wiring is a coaxial cable measuring 7 mm in diameter. For such a cable installed alone in the sheath, the radius of curvature of the concave cylindrical surface of the head needs to be greater than 3.5 mm.

According to one aspect of the invention, the upper face comprises, at the free end of the head, a rounded edge.

The sheaths intended to accommodate telecommunications or electricity cables are commonly sheaths referred to as “corrugated” sheaths made up of successive rings. The advantage of corrugated sheaths is that they can easily be bent in all directions to follow any path, but their main disadvantage is that their internal wall has annular markings against which the end piece of a needle or a cable can butt and jam when pushed along inside the sheath.

Thanks to the fact that its shape is rounded at the tip, the head of the needle slides over the internal surface of the internal rings of the sheath, without jamming against the lateral surface of one of these rings.

For example, for a typical sheath having 3 rings per cm, the rounding on the upper face needs to have a radius of at least 2 mm.

According to another aspect, the head has the overall shape of a bent-over disk, namely the shape of a tile of which the perimeter, when viewed from above, can be inscribed inside a circle or an oval. Thus, the lateral edges of the head exhibit no roughness liable to catch on the inside of the sheath.

According to one aspect of the invention, the free end of the head has a B-shaped profile.

By virtue of this aspect, the upper face of the head is rounded and has no roughness at the free tip of the head, even if, at this tip, the thickness between the top face and the lower face is not sufficient to achieve rounding within the mass. Specifically, since the overall shape of the head is that of a tile, namely partially cylindrical, the ability of the upper edge of the tile, which is convex, to jam against a ring of the internal wall of the sheath will be avoided by giving this edge the profile of an upper-case letter “B”.

According to one aspect of the invention, the maximum thickness between the upper face and the lower face is greater than or equal to the maximum of the thickness of the shank and of the thickness of the needle.

By virtue of this aspect, the thickest part of the assembly formed by the end-piece and the needle is indeed the head which guides. In this way, the head does not enter an empty space without the shank and the needle being able to follow it.

According to one aspect of the invention, the length of the head along the axis of the shank is less than three times the inside diameter of the sheath.

Because it is half-moon shaped over a certain length, the head has the overall shape of a tile cut from a cylinder. This partially cylindrical shape substantially limits the flexibility of the head even if the material is flexible. If the head is too long, it will bend only slightly, or not at all, in the bends along the sheath, and may become jammed. By limiting the head length to three times the inside diameter, such blocking does not occur.

According to one aspect of the invention, the head is pierced with a hole.

By virtue of this aspect, once the head begins to emerge from the sheath at the opposite end to the entry to the sheath at which the needle was inserted, it is possible to attach a cable to the hole in the head of the end piece and then install this cable in the sheath by removing the needle from the sheath from the entrance end of the sheath.

According to one aspect of the invention, the shank is of oblong cross section.

If the needle has a preferred plane of curvature, which it does for example if the needle has an oblong cross section, or if the needle function is performed by a cable of oblong section that is to be installed, such as for example an optical cable, it is necessary for the end piece to guide the needle while at the same time as far as possible respecting this preferred plane of curvature. Thanks to its oblong, for example oval or rectangular, cross section, the shank also has a preferred plane of curvature which can be aligned with that of the needle by fixing the end piece to the needle in a suitable manner. The progressive flexibility of the shank being exerted also in torsion, that allows the head progressively to enter a succession of changes of planes of curvature.

Such a succession of changes of planes of curvature arise, for example, when a first change in direction in one plane is immediately followed by a second change in direction in a different plane or, for example, in a straight line if the cable already installed is twisted in the sheath and resists the space-clearing action exerted by the head.

According to another aspect, the cross-sectional area of the rod decreases from the end fixed to the needle toward the head. Thus, if the shank is made of a homogeneous material, its flexibility increases toward the head, both in bending and in torsion.

According to another aspect, the shank is not only flexible but elastic, which means to say that it has a tendency to revert to its initial shape when deformed. Thus, the head of the end piece remains aligned with the needle and for guiding it in the free space between the internal wall of the sheath and the cable or cables installed, even after a twisting or flexing of the shank resulting from the path taken by the sheath and/or resulting from variations in alignment between sheath and installed cable.

According to one aspect of the invention, the flexibility of the shank, at the second end, is substantially equal to that of the needle.

By virtue of this aspect, there is no sudden variation in flexibility between the needle and the end piece, thereby preventing the formation of a sharp angle between needle and end piece at the fixing, at the pressure of the pushing force, and eliminating the risk of the fixing becoming blocked or even breaking at this point inside the sheath.

According to one aspect of the invention, the second end is fixed to the needle removably.

By virtue of this aspect, the end piece of the needle can be changed if the needle needs to be used for a sheath of a different diameter or if the number of cables already installed varies from one sheath to another. In addition, the end piece can thus be fixed to a cable intended to be installed by pushing, the cable then acting as a needle during the operation of installation in the sheath. The removable fixing may for example use a system of clip-fastening between a male part on the needle end and a female part on the end piece end, or vice versa, or may use any other known means of removable fixing.

The various aspects of the end piece that have just been described can be implemented independently of one another or in combination with one another.

The invention also relates to a method of inserting a needle in a sheath occupied by at least one previously installed cable, comprising a step of inserting a determined length of the needle into the sheath via an inlet of the sheath, the method being characterized in that the end of the needle is fixed to an end piece as has just been described, and in that the insertion step is preceded by a step of positioning the end piece at the entrance of the sheath, in an empty space situated between an internal wall of the sheath and the at least one installed cable, the positioning being adapted to the respective shapes of the free space and of the end piece.

### 4. INTRODUCTION TO THE FIGURES

Further advantages and features of the invention will become more clearly apparent from reading the following description of one particular embodiment of the invention, given by way of simple illustrative and nonlimiting example, and from studying the attached drawings, among which:

FIG. 1 shows an overall view of one example of an end piece according to the invention, in a situation of use with a needle, a sheath and a cable,

FIG. 2 shows an example of an end piece according to one aspect of the invention,

FIG. 3 is a view in cross section on A-A of FIG. 1,

FIG. 4 shows a detailed view of the inside of a corrugated sheath with an example of an end piece head according to one aspect of the invention,

FIG. 5 shows an example of the path of a sheath comprising several turns in different planes.

### 5. DETAILED DESCRIPTION OF AT LEAST ONE EMBODIMENT OF THE INVENTION

In the remainder of the description examples are given of various embodiments of the invention based on a corrugated sheath that is small in size and on an already-installed cable of the coaxial type of large size, but the invention also applies to other types of sheath and to several cables already installed in the same sheath.

When a single installed cable is mentioned, it must also be understood that this extends to several installed cables, and when an installed-cable size or diameter is mentioned, this means the size or diameter of the circle in which the cables bunched together can be inscribed.

FIG. 1 shows an overall view of one example of an end piece according to the invention, in a situation of use with a needle, a sheath and a cable.

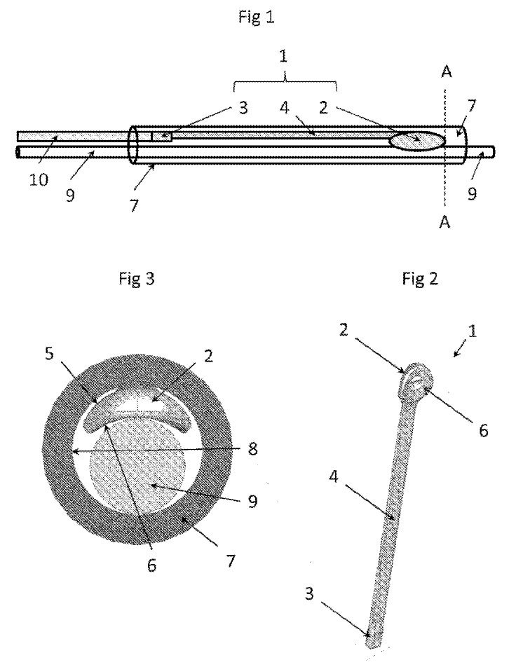

The cable 9 is installed definitively in the sheath 7, prior to the insertion of the needle 10. Fixed to the end of the needle 10 is an end piece 1. The needle 10 is pushed into the sheath 7 from outside the sheath 7. As it is being inserted, the needle 10 is preceded and guided by the end piece 1, which slips into the space left free inside the sheath 7 by the cable 9. A view of this space left free is given in FIG. 3, from a different viewpoint. The end piece 1 and its three parts 2, 3 and 4 is shown in greater detail in FIG. 2.

FIG. 2 shows one example of an end piece according to one aspect of the invention.

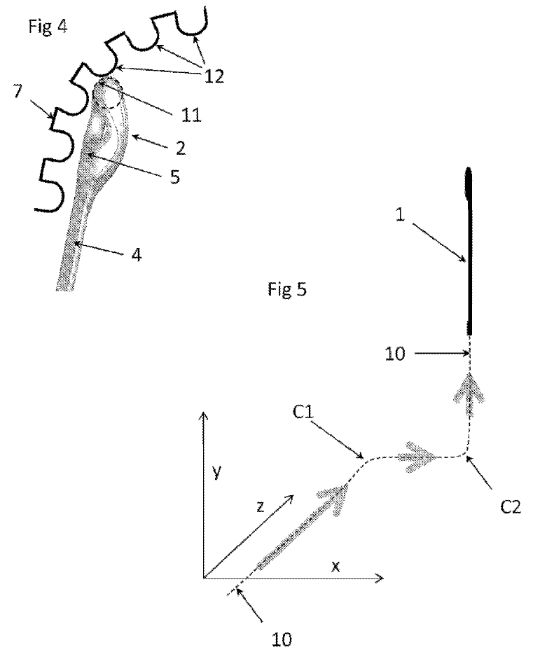

The end piece 1 comprises a head 2, an end 3 fixed to the needle 10, and a shank 4. The head has an upper face 5 and a lower face 6. The upper face 5, opposite to the lower face 6, is not visible in FIG. 2 but is visible in FIGS. 3 and 4, with reference to which the head 2 is described in greater detail.

The shank 4 is flexible and has a preferred plane of curvature which is the same as that of the needle 10. Specifically, the cross section of a needle is often rectangular which imposes greater flexibility on it in one plane than the others in which the flexibility may even be zero, and prevents the needle from twisting on itself as it is inserted into a sheath. Advantageously, the cross section of the shank 4 is flat, or, more precisely, not radially symmetrical, so as to give it a preferred plane of curvature which is substantially the same as that of the needle. Various shapes of flat cross section are suitable, for example rectangular, oval or more generally oblong. The end 3 of the end piece 1 is fixed to the needle 10 securely, which means to say without the freedom of the end piece to rotate with respect to the needle. The end piece 1 may potentially be removable in relation to the needle, if the end 3 of the end piece 1 and the end of the needle 10 are each equipped with a suitable fixing mechanism.

The flexibility of the shank 4 increases from the end 3 of the end piece 1, toward the head 2. The flexibility of the shank 4 is both in curvature in the preferred plane of curvature, and in torsion along the axis of its length. At the end 3, the flexibility is preferably identical to that of the needle. The flexibility is greater at the end 2 than at the end 3, something which allows the end piece 1 to enter changes in direction more easily as it advances along the sheath.

FIG. 3 is a view in cross section on A-A of FIG. 1.

The cable 9 previously installed in the sheath 7 is of a diameter less than the interior diameter of the sheath. In this cross-sectional view, it may be seen that when the cable touches the interior wall of the sheath, a free space is created, in the shape of a lunar crescent. The head 2 of the end piece occupies part of this free space by adopting a similar shape. When the head 2 is made from a material with a low friction coefficient, the dimensions of the head 2 may come close to, without equaling or exceeding, those of the free space, without the head becoming jammed in its progress through the occupied sheath. Preferably, the rest of the end piece and the needle therefore must not exceed the dimensions of the head.

A tile- or gutter-shaped profile is therefore suitable for the head, which therefore has an upper face and a lower face which are partially cylindrical. Preferably, the convex upper face 5 of this “tile” does not have exactly the same profile as its lower face 6.

Specifically, the radius of curvature of the upper face 5 is preferably less than that of a circle delimiting the interior wall of the sheath, so as to limit the points of contact between the head and the sheath, and therefore limit the friction as the head slides along inside the sheath.

The radius of curvature of the lower face 6 is itself preferably greater than that of a circle delimiting the perimeter of the cable, again so as to limit points of contact between the head and the cable, and therefore limit the friction as the head slides along the cable.

It will be appreciated that the crescent-shaped profile best suited to the head 2 may vary between a very slender crescent and a half-moon, depending on the number of cables installed in the sheath and depending on whether or not they are the same diameter.

FIG. 4 shows a detailed view of the inside of a corrugated sheath with one example of an end piece head according to one aspect of the invention.

Most of the sheaths used for cabling, whether this is for electricity, television, telephone or the Internet, are what are referred to as “corrugated” sheaths. These sheaths have rings on the outside as on the inside, the succession of which rings gives the sheath a tube shape. In the segments of the path followed by the sheath 7 which are not straight lines, the rings 12 on the inside of the sheath 7 are liable to place themselves directly in the path of the head 2 when the end piece 1 is progressing along the sheath 7. In order for the head 2 to be able to slide from one ring 12 to another unimpeded in the turns taken by the sheath 7, the free tip 11 of the head 2 is rounded on its upper face 5. The rounding of the free tip 11 can be inscribed inside an imaginary circle, depicted in dotted line in FIG. 4, the diameter of which is preferably greater than the spacing between two rings 12.

It will be appreciated that there is no need for the lower face 6 of the head 2 to have such a rounding because this face never comes into contact with the interior wall of the sheath but slips over the installed cable or cables, which are smooth.

If the thickness between the upper face 5 and the lower face 6 of the head 2 is insufficient to obtain a rounding that can be inscribed in a sufficiently large circle, one variation of the end piece according to the invention makes it possible to avoid the upper face from jamming against a ring. In this alternative form, in which the head adopts the shape of a very slender tile, the rounding needed is obtained by cutting the free tip of the head into the shape of an upper-case letter B. When the B is curved from the bottom upwards, the top of the tile thus obtained lies between the two curves of the B, and the lateral profile of the tile is rounded on the top.

FIG. 5 gives an example of the path of a sheath comprising several turns in different planes.

The path in this example starts off horizontal forward, then has a first bend C1 to the right in the plane {x, z}, followed by a second bend C2 upwards in the plane {x, y} perpendicular to the plane {x, z}. When the needle 10 is pushed in a sheath (not illustrated) following such a path, the succession of turns C1 and C2 therefore introduces torsion into the needle 10. Because the needle 10 has a certain torsional flexibility being elastic, its end is therefore pushed laterally toward the cable or cables (not illustrated) which need to be moved aside in order for the needle 10 to be able to continue to progress along the sheath.

The special quarter-moon shape of the head of the end piece 1 allows it to insinuate itself between the internal wall of the sheath and the cable or cables, even when the end piece 1 is attracted laterally by the elastic torsion return force of the needle 10. Thus, the needle 10 does not remain under torsion and its torsion is not accentuated to breaking point if sequences of turns in different planes are strung together.

The invention also relates to a method of inserting a needle into a sheath occupied by at least one already installed cable. This method uses a needle to the end of which is fixed an end piece as just described, and comprises:
a step of positioning the end piece at the entrance to the sheath, in a free space situated between the internal wall of the sheath and the at least one installed cable, the positioning being such that the convex upper face 5 of the head 2 of the end piece 1 is in contact with the internal wall of the sheath,
a step of inserting an end of the needle into an entrance of the sheath, at least until the end piece is fully inside the sheath,
a step of pushing, from outside the entrance to the sheath, a sufficient length of needle in the sheath, so that the head of the end piece reaches a determined point in the path of the sheath, which may be the exit from the sheath.

Once the determined point on the sheath has been achieved, generally the exit at the opposite end to the inlet, there are several known options that present themselves. If the needle is a cable which was intended to be installed and to remain in the sheath, the end piece is detached and kept for future use with another needle.

If not, the new cable to be installed is fixed to the needle emerging from the sheath at the determined point. This can be done in a number of alternative ways:
either the end piece is removed from the needle and the new cable is fixed to the needle using a known means, such as a sleeve for example,
or the new cable is attached to the head of the end piece fixed to the needle, using a known means employing the hole 12 in the end piece, for example a string,
or a second end piece is fixed to the cable and the two end pieces are attached to one another via their respective hole 12, using a known means.

Thereafter, the needle is pulled from the entrance of the sheath, with the consequence that the new cable is pulled through into the sheath.

It will be appreciated that if a second end piece is fixed to the cable and everything pulled into the sheath using the needle, the insertion method described hereinabove may also be used. In this case, the cable in the phase intended to be inserted acts as a needle, and the pushing step is replaced by a pulling step.

By virtue of the end piece according to the invention, the method of inserting a needle according to the invention allows a new cable to be inserted into a sheath already occupied by at least one already installed cable without the needle becoming jammed during the insertion phase.

An additional advantage of the end piece according to the invention is that it is also suitable for inserting a needle into a free cable sheath, by virtue amongst other things of the shape of its head which has no roughness on its free tip.

1-15. (canceled)

16. An end piece for guiding a needle intended to be inserted in a sheath occupied by at least one installed cable, the end piece comprising:
a free first end referred to as a head, of a shape suited to slipping in between an internal wall of the sheath and the at least one installed cable,
a second end fixed to the needle, and
a shank connecting the two ends, the shank having a flexibility that increases toward the head.

17. The end piece as claimed in claim 16, in which the head comprises a partially cylindrical convex upper face and a partially cylindrical concave lower face.

18. The end piece as claimed in claim 17, in which the convex upper face has a radius of curvature that is less than an interior radius of the sheath.

19. The end piece as claimed in claim 17, in which the concave lower face has a the radius of curvature that is greater than a radius of a section of a bundle formed by the at least one installed cable.

20. The end piece as claimed in claim 17, in which the upper face comprises, at the free end of the head, a rounded edge.

21. The end piece as claimed in claim 17, in which the free end of the head has a B-shaped profile.

22. The end piece as claimed in claim 17, in which a maximum thickness between the upper face and the lower face is greater than or equal to a maximum of the thickness of the shank and of a thickness of the needle.

23. The end piece as claimed in claim 16, in which the head has a length along an axis of the shank that is less than three times an inside diameter of the sheath.

24. The end piece as claimed in claim 16, in which the head is pierced with a hole.

25. The end piece as claimed in claim 16, in which the shank is of oblong cross section.

26. The end piece as claimed in claim 16, in which the flexibility of the shank, at the second end, is substantially equal to that of the needle.

27. The end piece as claimed in claim 16, in which the second end is fixed to the needle removably.

28. A method of inserting a needle in a sheath occupied by at least one previously installed cable, comprising the following acts:
inserting a determined length of the needle into the sheath via an inlet of the sheath, wherein an end piece is fixed to the needle, the end piece comprising:
a free first end referred to as a head, of a shape suited to slipping in between an internal wall of the sheath and the at least one installed cable,
a second end fixed to the needle, and
a shank connecting the two ends, the shank having a flexibility that increases toward the head,
wherein act of inserting is preceded by an act of positioning the end piece at the inlet of the sheath, in an empty space situated between an internal wall of the sheath and the at least one installed cable, the positioning being adapted to respective shapes of the free space and of the end piece.
